(19) United States
(12) Patent Application Publication
(10) Pub. No.: US 2019/0211980 A1
(43) Pub. Date: Jul. 11, 2019

(54) ROPE LIGHT

(71) Applicant: Kuo-Wei PAN, Hsinchu (TW)

(72) Inventor: Kuo-Wei PAN, Hsinchu (TW)

(21) Appl. No.: 15/923,582

(22) Filed: Mar. 16, 2018

(30) Foreign Application Priority Data
Jan. 9, 2018 (CN) 201810018352.8

(51) Int. Cl. F21S 4/26; F21V 23/00

(52) U.S. Cl. CPC F21S 4/26; F21Y 2103/10; F21V 23/002

(57) ABSTRACT

The present invention relates to a rope light, comprising: a hose which is provided with a hose body having an outer wall surface and an inner wall surface and a hose channel surrounded by the inner wall surface of the hose body; two bundles of conducting wires embedded in the hose body between the outer wall surface and the inner wall surface, and separated from each other and extending along a length direction of the hose channel; a plurality of light-emitting elements being electrically connected between the two conducting wires and being disposed within the hose channel; and a set of strengthen wire being embedded in the hose body between the outer wall surface and the inner wall surface, and the set of strengthen wire being separated from the two bundles of conducting wires and extending along a length direction of the hose channel.

### CROSS-REFERENCE TO RELATED APPLICATION

This application claims priority to Chinese Patent Application No. 201810018352.8 filed on Jan. 9, 2018, the entirety of which is hereby incorporated herein by reference.

### FIELD OF THE INVENTION

The present invention relates to a decorative light, and more particularly relates to a rope light.

### BACKGROUND OF THE INVENTION

Decorative light is widely used in various places to create a beautiful environment, such as at home, in a store, or in public places. Being one kind of decorative lighting, the rope light with excellent bendability is very popular because it can be easily bent into various patterns as desired. The rope light includes a hose and a long string of light bulbs mounted in the hose, which is used to embellish environment with its varying light bulb colors and/or luminous modes.

The high frequency of bending and tweaking from which the rope light may suffer at the moment of installation, however, causes a high incidence of damaged and broken interior wires which can lead to bad conduction. As a result, the conventional rope light is not sufficiently resistant to support repeated assembly and disassembly.

### SUMMARY OF THE INVENTION

Therefore, an objective of the present invention is to provide a rope light which possesses a better tensile strength.

In order to achieve the above, the present invention provides a rope light, comprising: a hose which is provided with a hose body and a hose channel surrounded by the hose body, the hose body having an outer wall surface and an inner wall surface, and the hose channel being formed as being surrounded by the inner wall surface; two bundles of conducting wires being embedded in the hose body as being disposed between the outer wall surface and the inner wall surface, and the two bundles of conducting wires being separated from each other and extending along a length direction of the hose channel; a plurality of light-emitting elements being electrically connected between the two conducting wires and being disposed within the hose channel; and a set of strengthen wire being embedded in the hose body as being disposed between the outer wall surface and the inner wall surface, and the set of strengthen wire being separated from the two bundles of conducting wires and extending along a length direction of the hose channel.

In one embodiment of the present invention, a rope light is provided that each bundle of conducting wire is formed by a plurality of conducting wires.

In one embodiment of the present invention, a rope light is provided that each bundle of conducting wire is a tinned copper wire.

In one embodiment of the present invention, a rope light is provided that the set of strengthen wire is a bundle of strengthen wires.

In one embodiment of the present invention, a rope light is provided that the set of strengthen wire is a plurality of bundles of strengthen wires, two bundles of strengthen wires being separated to each other.

In one embodiment of the present invention, a rope light is provided that a wall cross sectional thickness of the hose body decreases gradually from the first side of the hose body to the second side of the hose body, the first side of the hose body and the second side of the hose body being in the opposite cross sectional sides of the hose body.

In one embodiment of the present invention, a rope light is provided that the two bundles of conducting wires are disposed near the first side of the hose body.

By means of the technology used by the rope light of the present invention, a set of strengthen wire being embedded in the hose body allows the rope light of the present invention to entirely possess excellent tensile strength. Therefore, at the moment of installing the rope light of the present invention to decorate environment, the stretch length of the hose body due to bending and tweaking can be reduced, thereby reducing conducting wire damages, and improving the durability.

### BRIEF DESCRIPTION OF THE DRAWINGS

FIG. 1 is a schematic plan view illustrating a rope light according to one embodiment of the present invention; and

FIG. 2 is a schematic diagram of A-A cross-section view illustrating the rope light of FIG. 1.

### DETAILED DESCRIPTION OF THE PREFERRED EMBODIMENTS

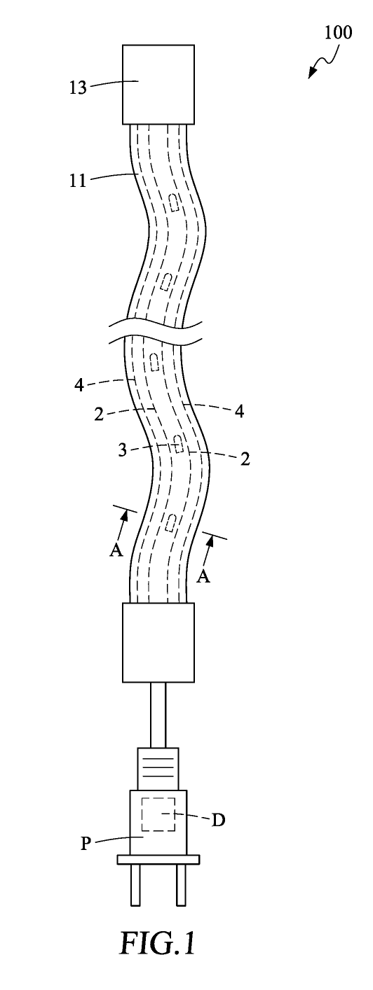

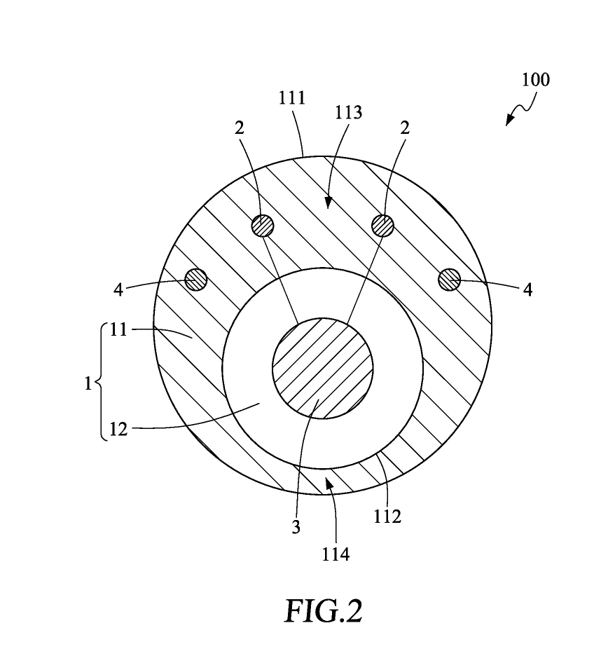

The preferred embodiments of the present invention are described in detail below with reference to FIG. 1 to FIG. 2. The description is used for explaining the embodiments of the present invention only, but not for limiting the scope of the claims.

As shown in FIG. 1 to FIG. 2, a rope light 100 according to one embodiment of the present invention comprises: a hose 1 which is provided with a hose body 11 and a hose channel 12 surrounded by the hose body 11, the hose body 11 having an outer wall surface 111 and an inner wall surface 112, and the hose channel 12 being formed as being surrounded by the inner wall surface 112; two bundles of conducting wires 2 being embedded in the hose body 11 as being disposed between the outer wall surface 111 and the inner wall surface 112, and the two bundles of conducting wires 2 being separated from each other and extending along a length direction of the hose channel 12; a plurality of light-emitting elements 3 being electrically connected between the two conducting wires 2 and being disposed within the hose channel 12; and a set of strengthen wire 4 being embedded in the hose body 11 as being disposed between the outer wall surface 111 and the inner wall surface 112, and the set of strengthen wire 4 being separated from the two bundles of conducting wires 2 and extending along a length direction of the hose channel 12.

In detail, each of the two ends of the hose 1 has a connecting part 13. One connecting part 13 is allowed to be connected to a driver D which is provided with the function of a rectifier, the driver D being electrically connected to a power plug P. The other connecting part 13 is allowed to be connected to an anti-electric-shock tail cover or a connecting part of another rope light.

The hose body 11 is a transparent circular hose which allows the light emitted by the light-emitting element 3 to pass through hose body. In this embodiment, the hose 1 is PVC transparent circular hose, which allows luminance and color of light emitted by the light-emitting element 3 to be completely performed.

As shown in FIG. 2, in the rope light 100 according to one embodiment of the present invention, a wall cross sectional thickness of the hose body 11 decreases gradually from the first side 113 of the hose body to the second side 114 of the hose body, the first side 113 of the hose body and the second side 114 of the hose body 11 being in the opposite cross sectional sides of the hose body 11. In other words, the axis of the hose channel 12 is offset from the axis of the hose body 11. The two bundles of conducting wires 2 are configured adjacent to the first side 113 of the hose body 11, i.e., the thicker side of the hose body 11. Since the first side 113 of the hose body 11 has its mechanical strength higher than the second side 114, protective effect on the conducting wires 2 can be better.

As shown in FIG. 2, embedded inside the hose body 11, the two bundles of conducting wires 2 being configured in equal spacing to each other are connected to positive electrode and negative electrode, respectively, and are electrically connected to each other via the light-emitting element 3. Each of the two bundles of conducting wires 2 has twenty-four conducting wires. All of the conducting wires are tinned copper wires having good antioxidative capacity, and can facilitate the welding with other components, for example, light-emitting element and resistor. However, in the other embodiment, the bundles of conducting wires 2 can also be other materials and/or quantities of wires.

As shown in FIG. 2, in the rope light 100 according to one embodiment of the present invention, there are two sets of strengthen wire 4 being embedded in the hose body 11. These two sets of strengthen wires 4 are separated to each other, and each set has a plurality of bundles of strengthen wires. The sets of strengthen wires 4 and the two bundles of conducting wires 2 are separated from each other so as not to cause compression between the sets of strengthen wires 4 and the two bundles of conducting wires 2 when temperature changes because of the difference in coefficient of thermal expansion. In detail, the configuration between the sets of strengthen wires 4 and the two bundles of conducting wires 2 is in equal spacing. The tensile strength of the sets of strengthen wires 4 is higher than the tensile strength of the hose body 11 so as to give the rope light 100 of the present invention a good tensile strength. Therefore, at the moment of installing the rope light 100 of the present invention to decorate environment, the stretch length of the hose body 11 due to bending and tweaking can be reduced, thereby reducing damages of the bundles of conducting wire 2, and improving the durability of the rope light 100.

In this embodiment, these two sets of strengthen wires 4 are configured in the first side 113 on the outer side relative to the bundles of conducting wires 2, respectively. In other embodiments, however, the sets of strengthen wires 4 can also be strengthen wires in other quantities and/or configured differently.

The light-emitting elements 3 are LED light bulbs being configured in equal spacing in the hose channel 12 in this embodiment. The light-emitting elements 3 can be connected in series, and can also be connected in parallel.

The above description should be considered only as an explanation of the preferred embodiment of the present invention. A person with ordinary skill in the art can make various modifications to the present invention based on the scope of the claims and the above description. However, those modifications shall fall within the scope of the present invention.

1. A rope light, comprising:
a hose which is provided with a hose body and a hose channel surrounded by the hose body, the hose body having an outer wall surface and an inner wall surface, and the hose channel being formed as being surrounded by the inner wall surface;
two bundles of conducting wires being embedded in the hose body as being disposed between the outer wall surface and the inner wall surface, and the two bundles of conducting wires being separated from each other and extending along a length direction of the hose channel;
a plurality of light-emitting elements being electrically connected between the two conducting wires and being disposed within the hose channel; and
a set of strengthen wire being embedded in the hose body as being disposed between the outer wall surface and the inner wall surface, and the set of strengthen wire being separated from the two bundles of conducting wires and extending along a length direction of the hose channel, a shortest distance between the inner wall surface and the set of strengthen wire plus a shortest distance between the outer wall surface and the set of strengthen wire is shorter than a shortest distance between the inner wall surface and the bundles of conducting wires plus a shortest distance between the outer wall surface and the bundles of conducting wires.

2. The rope light of claim 1, wherein each bundle of conducting wire is formed by a plurality of conducting wires.

3. The rope light of claim 2, wherein each bundle of conducting wire is a tinned copper wire.

4. The rope light of claim 1, wherein the set of strengthen wire is a bundle of strengthen wires.

5. The rope light of claim 1, wherein the set of strengthen wire is a plurality of bundles of strengthen wires, two bundles of strengthen wires being separated to each other.

6. The rope light of claim 1, wherein a wall cross sectional thickness of the hose body decreases gradually from the first side of the hose body to the second side of the hose body, the first side of the hose body and the second side of the hose body being in the opposite cross sectional sides of the hose body.

7. (canceled)

8. The rope light of claim 1, wherein the set of strengthen wire is a bundle of non-conducting strengthen wires.
